(19) United States
(12) Patent Application Publication
(10) Pub. No.: US 2022/0324367 A1
(43) Pub. Date: Oct. 13, 2022

(54) System, workflow, method and apparatus of a solar smart delivery signage trailer or cart (SS-DST) with UV disinfecting smart lockers, food delivery capabilities, advertisement screens and on demand help desk video calls that can be towed by an autonomous or non autonomous vehicle or robot.

(71) Applicant: Willis Dennis Grajales, Little Elm, TX (US)

(72) Inventor: Willis Dennis Grajales, Little Elm, TX (US)

(21) Appl. No.: 17/227,356

(22) Filed: Apr. 11, 2021

Related U.S. Application Data
(60) Provisional application No. 63/172,005, filed on Apr. 7, 2021.

(51) Int. Cl. B60P 3/025; G06Q 30/02; G06N 20/00; G05D 1/00; H04W 4/40; B60J 7/00; B60R 16/023; B60L 8/00; B60L 53/16; H04N 7/18

(52) U.S. Cl. CPC B60P 3/025; G06Q 30/0251; G06N 20/00; G05D 1/0011; H04W 4/40; B60J 7/00; B60R 16/0231; B60L 8/003; B60L 53/16; G05D 1/0088; H04N 7/183; H04W 88/10

(57) ABSTRACT

The invention discloses a solar smart delivery signage trailer or cart (SS-DST) that may be attached to any autonomous or non-autonomous vehicle. The (SS-DST) function is an advertisement, food storage, food delivery, public wifi hotspot, and may be towed by any vehicle. The (SS-DST) has the option of providing a virtual delivery man video chat to customers via a screen, speakers, and microphone. The (SS-DST) has solar power capabilities used to power its equipment and can charge other electronic vehicles towing the innovative trailer. The (SS-DST) has the option of delivering advertisement via a roof installation signage display. All systems can be edited or monitored via wireless cellphone networks or wifi remote connections. The lockers are temperature regulated and can be monitored via a remote controller (VDM) from anywhere in the world.

### RELATED APPLICATIONS

This U.S. patent application is a continuation of U.S. Provisional Application No. 63/172,005 filed Apr. 7, 2021 titled “System, workflow, method and apparatus of a solar smart delivery signage trailer (SS-DST) with UV disinfecting smart lockers, food delivery capabilities, advertisement screens and on demand help desk video calls that can be towed by an autonomous or non autonomous vehicle or robot.”.

### BRIEF DESCRIPTIONS OF THE DRAWINGS

FIG. 1A Illustrates a flow diagram of a method for performing a pickup and delivery service with the (SS-DST) system and its towing vehicle.

FIG. A Illustrates a pictorial diagram of a solar smart delivery signage trailer (SS-DST) attached to a autonomous vehicle or non autonomous vehicle of two types models both with one of a width of 21.5 inches or less and one model of 41.5″ or more which length may say depending on customized model selections. Also with a picture of a shopping car and a human beside the (SS-DST) trailer or cart for size comparison.

FIG. B illustrates a pictorial diagram of a solar smart delivery signage trailer (SS-DST) or cart with equipped with a signage advertisement screen on top of a cover or roof box, and its 360 cameras or cameras on all 4 sides of the cart or trailer with its parts and add on, cover, a battery pack socket plug, pizza smart lockers, large smart lockers, two tablet touch screen computer screen one for virtual calls and information gathering and one for locker code to open lockers, speakers, bumpers and wheels.

FIG. C Illustrates embodiments of group of computers running multiple software inside and outside the (SS-DST) to intercommunicate each part, forward and consolidate information to a network via cellular wireless networks, hotspot wifi for the use of remote control and share monitoring to an remote works (virtual delivery man) or to AI system of all tablets or computers, computer information, energy battery pack information, smart locker computers for code, smart locker and video calls, locker temperature control, and autonomous vehicle computers. Also the pictorial representation of an advertisement forwarder screen share to the a secondary advertisement screen on the towing vehicle.

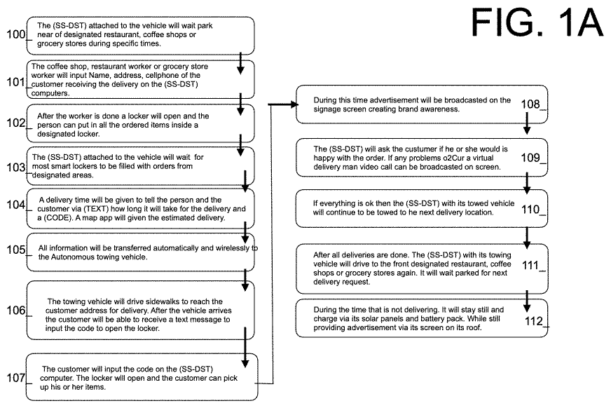

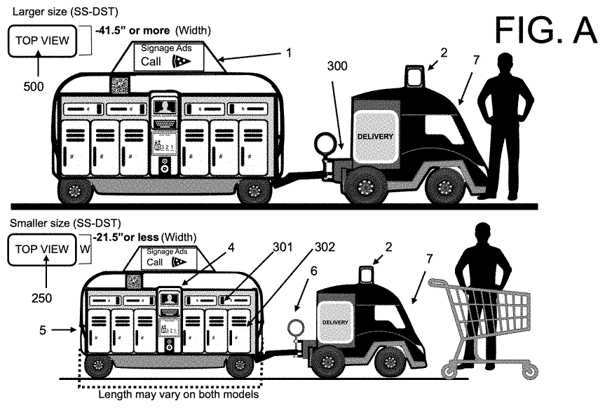

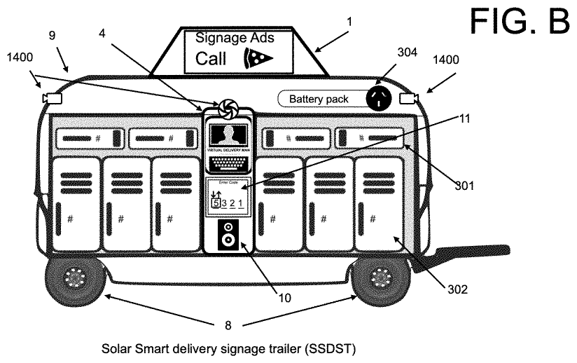

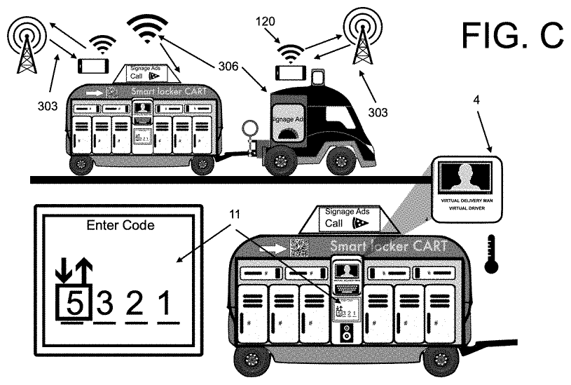

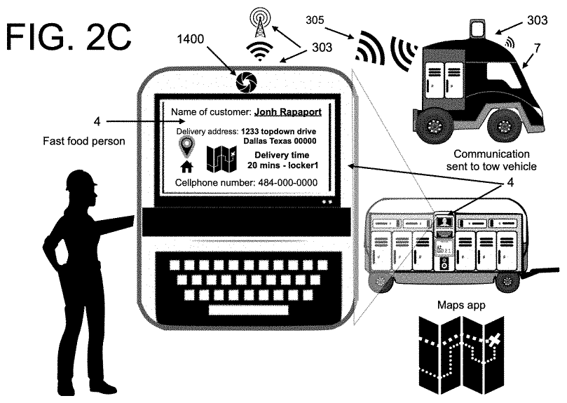

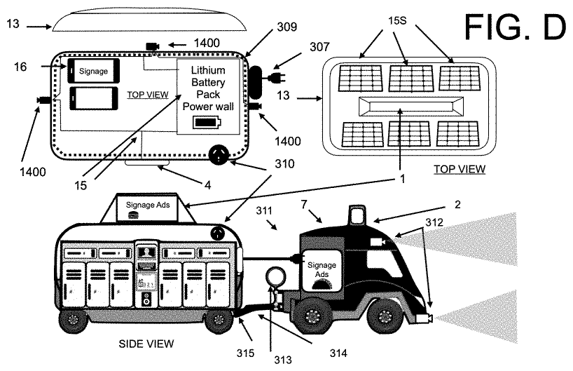

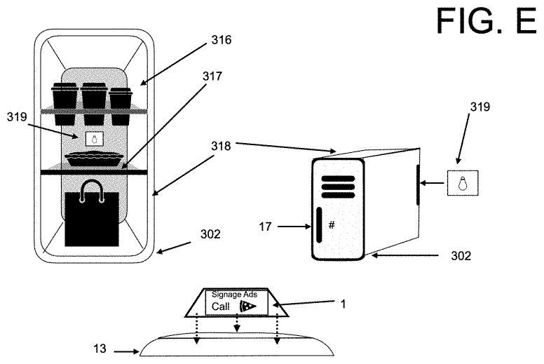

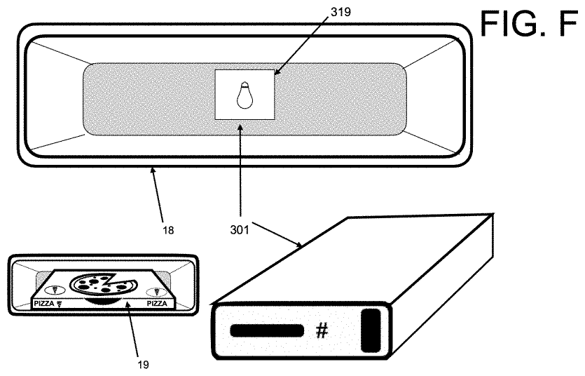

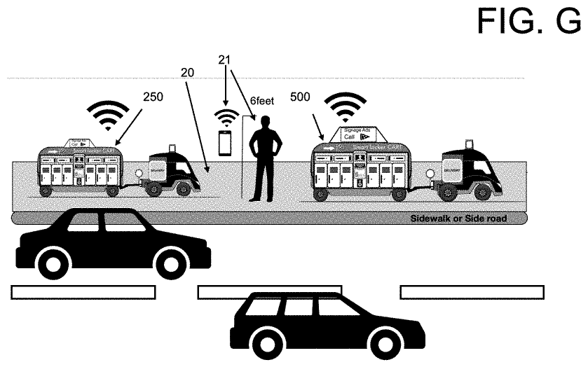

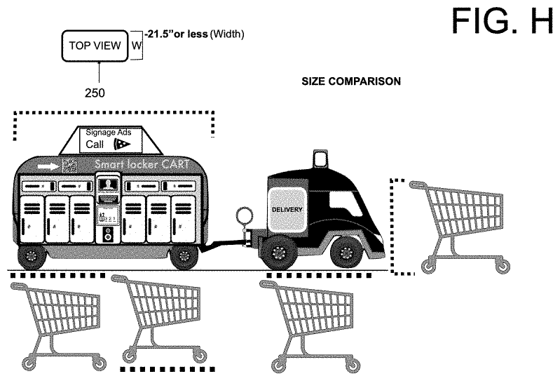

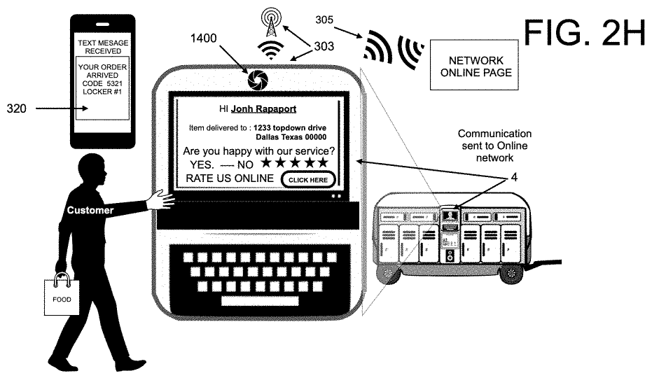

FIG. 1C Illustrates pictorial diagram embodiment of the of software running inside (SS-DST) computers, where the external computer sun a software to collect the customer data information name, deliver address, cellphone number, email, estimated delivery and code generated. Where the customer information from the (SS-DST) is sent to a sent to a network and its also sent to the towing vehicle computers to give direction to the autonomous or non autonomous vehicle of the delivery location so it can drive to the location using autonomous driving technology and map.

FIGS. D Illustrate pictorial diagram embodiment of the (SS-DST) and its internal and external components.

FIG. E—Illustrate pictorial diagram embodiment of the insulated temperature control large smart locker, cup holder adapters, division and some internal and external components, its UV disinfecting light system and external adapter of the advertisement signage sign.

FIG. F— Illustrate pictorial diagram embodiment of the insulated temperature control small pizza box smart lockers system and its internal and external components and its UV disinfecting light system.

FIG. G—Illustrate pictorial diagram embodiment Illustrates of a method for transporting the small (SS-DST) towed by vehicle using sidewalks and side road while also providing public wifi hotspots a person for size comparison.

FIG. H— Illustrate pictorial diagram embodiment Illustrates of a (SS-DST) trailer with its towing vehicle for size comparison of width and length. Where the length of the the towing vehicle can be similar length of one shopping cart of any size and the trailer or cart can be or one or two can be similar to one or two shopping carts in length. Where the width of the towing vehicle and the (SS-DST) can be 21.5 inches more or less depending on the vehicle or robot used.

FIG. 2H—Illustrate pictorial diagram embodiment Illustrates of a cellphone receiving a text message of code to open the smart lockers. The screen on the (SS-DST) will showing the name, address, and link to review the delivery service provided with one or more stars. Where the (SS-DST) are connected to the internet review system, a network online.

### DETAILED DESCRIPTION

The present disclosure pertains to a solar smart delivery signage trailer (SS-DST) (cart) that may be towed by a vehicle or robot for food delivery. (FIG. D; 7,315, 313,311). The trailers and towing vehicles can be of any size. The trailers come in a large design or a small design. (FIG. A; 1,500, 250). The large size (SS-DST) width starts from 41.5 inches or larger, and the length may vary depending on the design. The smaller size (SS-DST) width starts from 21.5 inches or less, and the length may vary depending on the design. Most of the (SS-DST) length will be near the size of two or three shopping carts in size. (FIG. H).

The delivery vehicles can be of any size, and most towing vehicles or robots may be the size of one or two shopping carts in length. (FIG. H; 250). The height in both types may vary depending on the design and models. (FIG. G; 21). The trailers can be towed by an autonomous vehicle within similar width measurements as the width (SS-DST) models. Autonomous towing vehicles can have LIDAR technology or camera technology for self-driving capabilities and to verify road conditions. (FIG. D; 2,7,312,2,1400). The (SS-DST) can also be towed by a non-autonomous vehicle via a universal adapter. (FIG. A; 300).

The towing vehicles can be controlled remotely or physically. Usually, these (SS-DST) will be small enough to fit and run on sidewalks. (FIG. G; 20). The autonomous or non-autonomous towing vehicles can tow the (SS-DST) via a tow hitch attachment and its adapter. (FIG. D; 313). All (SS-DST) have a tongue, brake, tow hitch and tow arch latch, and four wheels. (FIG. D; 313,314,315,7). The trailers' top will have a cover SS or roof box to protect the battery, cameras, smart lockers, advertisement signage, computers, and wires. (FIG. D; 13).

The top cover will also have solar panels that charge the lithium battery pack small power wall under the cover. (FIG. D; 308,15,309). These batteries will power all the electronics running in the trailer. (FIG. D; 1,4,11,16,302,301). The (SS-DST) runs multiple computers with multiple cellphone providers and also provides a hotspot to other computers in its system as a backup. The (SS-DST) may provide a hotspot connection to the autonomous or non-autonomous towing vehicle.

The towing vehicle may have multiple computers to control the vehicle, depending on the models and maker. (303,306,120). Some of the hotspots can be public hotspots for customers near the (SS-DST). (FIG. G; 21). The (SS-DST) may run on any cellphone network 4G, 5G, 6G, wifi. (FIG. C; 303, 305, 306,120). The (SS-DST). The (SS-DST) can be parked or attached to any autonomous or non-autonomous electric vehicle via an adapter.

The (SS-DST) can be towed on sidewalks or side roads if needed. (FIG. G; 20, 250, 500). The (SS-DST) can vary in size depending on the locations. (FIG. A). The SS-DST solar panels in the top cover that charge a lithium power battery pack. (FIG. D; 15). The battery power pack powers the following devices: Led advertisement signage, smart locker system, video call system computers, Led lights and speakers, cameras, and microphones. (FIG. D; 309,16) (FIG. B; 10,4,11,302,301,9).

In some cases, the (SS-DST) can donate power to the autonomous or non-autonomous electric towing vehicle or robot. (FIG. D; 311). The (SS-DST) also has a plug to charge its batteries by charging station if needed. (FIG. D; 307, 311, 310). The roof advertisement sign is connected to a computer that can be controlled and changed via cellphone networks via remote control and screen share. (FIG. D; 16,1,13, 305). The virtual delivery man (VDM) is a person located in a remote location that can access the (SS-DST). (FIG. C; 4).

The (VDM) can verify and report disruptions to the (SS-DST). The VDM can also change the advertisements screen independent of where the (SS-DST) is located. One of the functions of the (SS-DST) is food storage via insulated UV self-cleaning lights lockers. (FIG. E; 319,316,17,302,317). All the smart locker used for delivery are insulated temperature-controlled to deliver food and groceries at correct temperatures. (FIG. E; 318) (FIG. F; 18). The (SS-DST) has a pintle hook to attach any autonomous car or small towing vehicle.

The use of a towing vehicle is to help in food delivery, groceries, or package delivery. In various embodiments, the (SS-DST) are similar to airport baggage cart but smaller and with smart temperature-controlled smart lockers and compartments configure to lock and unlock via a code. (FIG. C; 11). Most (SS-DST) attached to his towing vehicle will be parked in front of main shopping plazas or near fast food areas. (FIG. 1A; 100-112). When people order food online or via phone, the fast-food restaurant or grocery worker will have an order number and will package items on the smart lockers system for delivery.

The restaurant or grocery store worker will input customers' information, put items into one of the lockers for delivery. A code will be generated to open the lockers when the item arrives at the customer's location. The customer will use this code generated to open the lockers. This information is sent to the vehicle.

The towing vehicle will find a route via sidewalks using a map (walk) application. Most (SS-DST) with or without its towing vehicle will be stationary in front of restaurants, coffee shops, or grocery stores for pick up. The smart lockers with designate a code for the given order or person ordering the store. (FIG. 1A; 100-112) This code will open the locker with his or her delivery package. The following food that can be delivered via the (SS-DST) and towing vehicle are coffee, drinks, pizza, hamburgers, tacos, or groceries. (FIG. E) The (SS-DST) has smart lockers that are insulated to create temperature control. After the delivery is done, the advertisement sign may inform the customer if they have any problems.

They can contact the virtual delivery man (VDM) via the video chat screen on the trailer. If the customer declines, he or she can leave. If the customer accepts, they can talk to the Virtual delivery man in a remote location where the virtual delivery man (VDM) coordinates with the restaurant or grocery store to fix the order. These (SS-DST) can be stationed in parking lots or sidewalks. When these (SS-DST) will start to be towed by a vehicle, the (VDM) will ensure that the system is ready for use by troubleshooting the system if needed.

The (VDM) will be in a remote location but can control and view the surrounding 360 cameras and inspect the environment. (FIG. D; 1400, 312). The (VDM) verify weather conditions for each individual (SS-DST) in his or her district. The (SS-DST) has a brake system that can be controlled by the (VDM) remotely in case it is needed. More connection can be made via a remote control interface to the computer system that controls the brakes.

In some cases, the (autonomous vehicle that is towing the (SS-DST) can also be controlled by the Virtual Delivery man if needed if the controls are from the same maker. The (SS-DST) can be towed by other makers as well if needed. The locker systems contain insulation and trays that can be used to situate food to prevent spills or damage. The top of the (SS-DST) contains small smart lockers to hold pizza boxes of any size. These small pizza box lockers are also temperature-controlled. (FIG. F).

The (virtual Delivery man (VDM) can also view the temperature of each locker verify that all lockers are in correct temperatures. Depending on food if needed. (FIG. C; 4). In case of accident where the (SS-DST) is hit or damaged the (DVM) will receive notification from one or any of the computer systems in the (SS-DST). The (VDM) via remote control can view the remote location via GPS and call notify police or emergency department of accidents.

After the food is delivered, the (SS-DST) can be towed again to the coffee shop, restaurant or grocery store parking. Most (SS-DST) will be parked near coffee shops, fast food, or grocery stores. A person with the online order information can go to the (SS-DST) and input customer information on the computer next to the smart trailers. The store worker will input the Name, address, cellphone of the customer receiving the delivery. (FIG. 2C).

After the person is done a locker will open, and the store worker can put in all the ordered items inside a designated locker. A delivery time will be given to tell the person and the customer how long it will take for the delivery. A map app will give the estimated delivery using API. The information will be sent to the autonomous towing vehicle automatically.

The towing vehicle will drive sidewalks to reach the customer's address for delivery. (FIG. G; 20,21,500,250). After the vehicle arrives, the customer will be able to receive a text message with the code and locker. (320). The customer will input the code on the (SS-DST) computer. (FIG. 2H) The locker will open, and the customer can pick up his or her items.

During this time, an advertisement will be broadcasted on the signage screen including a QR code for the customer to rate one star or 5 start, and creating brand awareness. The (SS-DST) will then continue to be towed to the next location. (FIG. 1A). The advertisement can use the patient information with an algorithm to bring a specificity tailored advertisement to the customer in some cases if configured. (FIG. 2H).

What is claimed is:

1. A solar smart delivery signage trailer (SS-DST) is a small 4 wheel trailer or 4 wheel cart for use with a autonomous or non autonomous towing vehicle or robot comprising:
a main body;
a trailer or cart
a top roof cover or roof box.
a multiple computer systems.
a battery pack
a smart locker system
a attached towing vehicle or robot

2. The trailer or cart of claim 1, wherein the trailer or cart has 4 wheel trailer chassis or 4 wheel cart chassis spaced apart to its corners and a tow hitch with adapter to attach a towing small vehicle, a cart Tongue or trailer tongue and a cart or trailer torsion axle.

3. The trailer or cart of claim 1, wherein the trailer or cart has a 4 tires and can be of any type and size depending on design and models and has a brake and tow arch latch.

4. The trailer or cart of claim 1, where in the trailer or cart is width is is the size of a shopping cart or larger and the length is about the size of one or two shopping carts or larger.

5. The trailer or cart of claim 1, where in the trailer or cart has a roof and walls frame of metal, or any other material depending on model and may have reflective tapes is places all sides of the trailer.

6. The roof cover or roof box adapter in claim 1, where in the trailer has a roof adapter cover that is weather proof and is similar to a car or truck roof box that is enclosed and its attached to the trailer or carts roof and it will be used to house a set of multiple computers running on any operating system with cellphone networks capabilities, lithium battery storage pack, inverter, charge controller, charging cable plug, charging socket, multiple cameras, cables, LED light strips inside and cables for external solar panels and advertisement screen above the the exterior of the cover or roof box.

7. The roof cover or or roof box adapter in claim 6, where in the trailer roof cover or roof box adapter may be translucent in some areas, may be solid of any type of material, weather proof, sturdy, contain brackets to securely attach to the roof of the trailer or cart and has solar panels attached in its exterior and extra bracket holding a 2 sided weather proof advertisement LED screen signage.

8. The roof cover or or roof box adapter in claim 1, where in the trailer has a roof adapter cover made of metal or any other material that houses a set of multiple computers running on any operating system and that can connect to different wireless cellphone network, lithium battery storage pack, inverter, charge controller, multiple cameras, cables, LED light strips inside and cables for external solar panels and advertisement screen.

9. The smart locker system in claim 1, wherein the smart lockers system that are built in the trailer or cart that are connected to an array of computers, and touch screen computer tablet that control the temperature regulated insulated individual lockers and pizza box lockers, self cleaning uv disinfecting lights systems, customer information transfer to autonomous or non autonomous vehicle, advertisement signage computers software and provide virtual video calls by a remote delivery man or support associate if needed.

10. The multiple computer systems in claim 1, wherein the multiple computer systems and all its smart locker computer and systems, security cameras, advertisement screen software, lithium battery charge information software and proximity cameras can be remotely controlled, monitored and troubleshooted via remote control connection and screen sharing connection via 4G, 5G, 6G or wifi from any designated service person (virtual delivery man) in a remote location if needed.

11. The multiple computer systems in claim 1, wherein some of the computer are designated for analyzing camera surrounding and minimizing any accidents with pedestrians and or objects by sending the information to the towing trailer if needed.

12. The smart locker system in claim 1, where in the smart lockers system has 4G, 5G, 6G or (hotspot) wifi online capabilities and can gather data inputed by a person including name, address, delivery address, cellphone number, email and/or items ordered and send information to a network and forward the information to a towing vehicle to deliver the (SS-DST) to specific locations to deliver item (food, coffee, groceries, or anything) on time to the customers.

13. The smart locker system in claim 1, wherein the smart locker system can communicate with the advertisement signing computers to deliver information targeted or non targeted advertisement to customers upon arrival at the destination or after the customer picks up their order while they opens the locker via a designated code. Where the the computers can also provide online link to rate the experience online 1 or 5 stars.

14. The trailer or cart of claim 1, wherein the trailer can connect and send customer information, customer deliver delivery information or network authorization information to an autonomous towing vehicle or robot that can be attached to the trailer using via cellular wireless networks, hotspot or wifi depending on configuration and software used.

15. The multiple computer systems of claim 1, wherein multiple computer systems inside the (SS-DST) have multiple cellphone network capabilities and can provide hotspots for its computers interconnections and for customer public use if needed.

16. The attached towing vehicle or robot of claim 1, wherein the attached vehicle or robot can be of same maker or different company makers as long as the adapter to connect to the tow hitch is installed and may have reflective tapes is places all sides.

17. The attached towing vehicle or robot of claim 1, wherein the towing vehicle or robot may be an autonomous vehicle, vehicle with a driver, or a vehicle with a remote driver where the vehicle can are be remotely operated via remote software technology to control the vehicle from anywhere in the world and may have computer systems that connect to the computer system of the (SS-DST).

18. The battery pack of claim 1, wherein the battery pack can gather solar energy from its solar panels or can be charged via charging socket on its side of the cover or roof box at a charging station.

19. The battery pack of claim 1, wherein the battery pack can give or donate energy to the any electric towing vehicle or robot if needed via a wire charging plug.

20. The attached towing vehicle or robot of claim 1, wherein the towing autonomous vehicle or robots may use self driving technology using single or multiple LIDAR systems or multiple camera and artificial intelligence and machine learning technology to drive in side roads or sidewalks autonomously and to minimize any accidents while arriving at the delivery sites to deliver the (SS-DST) with its smart lockers filled with items (food, groceries or anything) to customer at their delivery locations.
